(19) United States
(12) Patent Application Publication
(10) Pub. No.: US 2014/0116533 A1
(43) Pub. Date: May 1, 2014

(54) Universal Pneumatic Coupler

(71) Applicant: PLEWS, INC., Dixon, IL (US)

(72) Inventor: E. Mark Edler, Pearl City, IL (US)

(73) Assignee: Plews, Inc., Dixon, IL (US)

(21) Appl. No.: 13/834,084

(22) Filed: Mar. 15, 2013

Related U.S. Application Data
(60) Provisional application No. 61/719,776, filed on Oct. 29, 2012.

(51) Int. Cl. F16L 55/07

(52) U.S. Cl. CPC F16L 55/07
USPC 137/315.01

(57) ABSTRACT

A universal coupled includes a body member with a plug entry end and an opposite fluid flow outlet end with a retainer nut for maintaining a biasing member and axially slidable plug valve in the body member wherein the plug includes multiple, discrete diameter axially joined sections which are sized to uniquely receive discrete plugs. A sleeve slidably mounted on the body member engages retaining balls which radially engage and retain a plug inserted into the body member or may be manually and axially displaced to release the retaining balls.

### CROSS REFERENCE TO RELATED APPLICATION

This is a utility application incorporating by reference and claiming priority to provisional application Ser. No. 61/719,776 filed Oct. 29, 2012 entitled “Universal Pneumatic Coupler”.

### BACKGROUND OF THE INVENTION

In a principal aspect, the present invention comprises a coupler for air lines and fluid gas lines which is capable of co-action or coupling with multiple types or styles of plugs.

Connection of air lines for pneumatically driven tools and the like is often effected by attachment of a flexible air line hose with an attachment plug on the end of the hose to a coupler affixed to the tool. Following is a listing of patents directed, in general, to this type of technology:

| Pat. No. | Title | Issue Date |
|---|---|---|
| 5,535,985 | Quick Coupling for Pressure Conduit with | Jul. 16, 1996 |
| | Controlled Disengagement | |
| 5,445,358 | Exhaust Type Quick Action Coupler | Aug. 29, 1995 |
| 5,294,092 | Quick Disconnect Coupler | Mar. 15, 1994 |
| 4,583,711 | Rigid Mount Coupler with Flow Check Stop | Apr. 22, 1986 |
| 4,098,292 | Locking Means for Self-Sealing Quick | Jul. 4, 1978 |
| | Disconnect Couplings | |
| 4,060,219 | Quick Disconnect Coupler and Safety Check | Nov. 29, 1977 |
| | Valve | |
| 3,567,175 | Quick Release Coupling | Mar. 2, 1971 |
| 3,423,063 | Valved Safety Speed Coupler | Jan. 21, 1969 |
| 3,404,705 | Coupling and Valve Mechanism | Oct. 8, 1968 |
| 3,140,072 | Locking Mechanism in Quick-Connect- | Jul. 7, 1964 |
| | Disconnect Coupling | |
| 6,702,254 | Universal Safety Coupler | Mar. 9, 2004 |
| 7,028,711 | Quick Connecting Safety Coupler | Apr. 18, 2006 |

However, many types or styles of plugs are available often requiring a particular coupler designed to be compatible with a particular style of plug. Efforts have been made to provide universal couplers capable of co-acting with multiple plug designs. Nonetheless, there has remained a need for a mechanically unique and simple coupler capable of coaction with a variety of plugs. Another desirable characteristic of a coupler is to incorporate a minimal number of component parts arranged to provide a compact sized coupler.

### SUMMARY OF THE INVENTION

Briefly the coupler of the present invention comprises a cylindrical body member with a generally constant diameter throughbore having a plug entry end and an opposite air outlet end. A female air passage nut attached to the air outlet end of the body member engages a biasing spring against a generally uniform diameter, cylindrical, axially slidable valve member in the throughbore. A flange at the plug entry end of the throughbore limits the axial movement of the spring biased valve member in the direction of the outlet end of the body member.

The slidable valve member includes an axial counterbore in the end adjacent the plug entry end of the body member. The counterbore is comprised of a series of decreasing diameter sections. The valve member further includes multiple radial air exit passages or slots from the minimum diameter section of the counterbore. Internal annular seals are provided in the counterbore and on the outside surface of the slidable valve member.

A sleeve is slidably mounted on the outside of the body member and is axially spring biased to engage multiple retainer balls which project radially through passages in the body member so that may be fitted into a circumferential groove of a plug inserted into the body member.

The coupler is capable of engaging and retaining multiple types of plugs. Thus, plugs which include an axial air or fluid flow passage and also include a circumferential outer groove may be inserted into the plug entry end of the coupler body member. Upon insertion the plug engages and axially moves the valve member toward the opposite end of the coupler. Upon such movement the outer sleeve of the coupler slides axially toward the plug entry end of the body member thereby displacing the retainer balls radially into engagement with the plug groove to retain the plug joined to the coupler. The axially displaced valve member radial passages or slots are simultaneously aligned to provide a fluid flow passageways through the valve member and the female air passage nut. The various seals and counterbore sections of the valve member are designed to effect sealing the air flow passage for various styles of plugs inserted into and locked to the coupler. The coupler thereby is capable of connection with the multiple plug styles.

Thus, an object and aspect of the invention is to provide a universal coupler which effects a locked connection with multiple plug styles.

Another object and aspect of the invention is to provide a coupler which provides a uniquely compact profile and is not bulky or excessively unwieldy.

A further object and aspect of the invention is to provide a coupler which locks with a plug by pushing the plug into the coupler and which is easily released by manual sliding movement of a sleeve incorporated on the outside of the body member of the coupler.

Another object and aspect of the invention is to provide a coupler having a minimum number of component parts.

Yet another object and aspect of the invention is to provide a universal coupler which is easy to utilize with existing pneumatic tools and pneumatic fluid lines.

These and other objects, advantages and features of the invention are described in greater detail in the following description of an embodiment of the invention which follows.

### BRIEF DESCRIPTION OF THE DRAWING

In the detailed description which follows reference will be made to the drawing comprised of the following photographs and figures:

FIG. 1 is a side elevation depicting an embodiment of the coupler of the invention with a typical plug positioned for engagement with the coupler;

FIG. 2 is a side elevation of the plug of FIG. 1 inserted with and locked into the coupler;

FIG. 3 is a further side elevation of the plug of FIG. 1 inserted in the coupler wherein a release sleeve has been actuated to permit removal of the plug from the coupler;

FIG. 4 is a side elevation of an alternate style of plug compatible with the coupler of FIG. 1;

FIG. 5 depicts yet another plug style compatible with the coupler of FIG. 1;

FIG. 6 is a cross-sectional view of the coupler depicted in FIG. 1 taken along a plane parallel to the longitudinal axis of the coupler and through the centerline axis of the coupler;

FIGS. 7, 7a and 7b are a series of drawings depicting the body member of the coupler of FIG. 6;

FIGS. 8 and 8a are a series of figures depicting the female nut of the coupler of FIG. 6 wherein FIG. 8a is a sectional view of FIG. 8 taken along the line A-A;

FIGS. 9 and 9a is a series of figures depicting the external slidable sleeve of the coupler of FIG. 6 wherein FIG. 9a is a section view along the line A-A of FIG. 9;

FIGS. 10 and 10a are a series of figures depicting the slidable valve of the coupler of FIG. 6;

FIGS. 11 and 11a are a side and end view depicting the spring interposed in the female nut against the slidable valve for biasing the slidable valve of FIG. 10;

FIGS. 12 and 12a are a side and end view of the spring for biasing the external sleeve of FIG. 9;

FIG. 13 depicts a view of a ball bearing located within a passage of the body member of FIG. 7 and which may be engaged by the sleeve of FIG. 9;

FIGS. 14, 14a, 15 and 15a comprise views of seals which are retained within a counterbore of the valve depicted in FIG. 10; and

FIGS. 16, 16a, 17 and 17a comprise views of O ring seals incorporated in grooves on the exterior of the valve member of FIG. 10.

### DESCRIPTION OF AN EMBODIMENT OF THE INVENTION

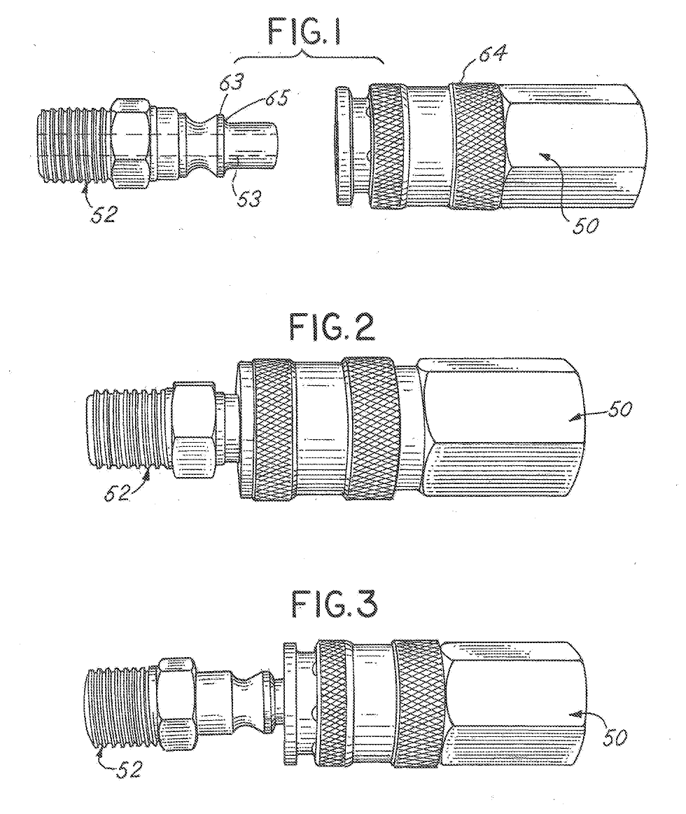

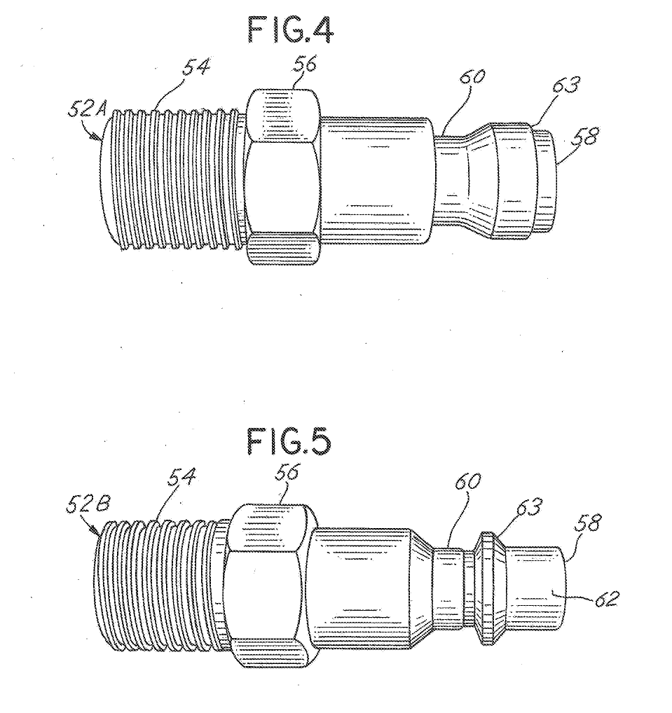

Referring to the figures, the FIGS. 1-3 depict a coupler 50 which is designed to receive a plug 52 as well as other plug designs. The plug 52 depicted in FIGS. 1-3 is any one of a variety of plugs provided from various manufacturers or other sources. FIGS. 4 and 5 illustrate other distinct plug styles 52A and 52B. The plug 52 typically includes a threaded male end 54; an intermediate hexagonal shoulder 56 to facilitate threading the plug 52 to a pneumatic tool or hose for example and an insertion end 58 which includes a groove 60 and a fluid flow stem 62. Thus, the plug 52 may be threaded into or otherwise connected to a hose or tool or some other air operated or pneumatic or fluid driven device or line. An axial throughbore 53 in the plug 52 provides a fluid flow pathway through the stem or projection 62 and the plug 52. The groove 60 provides a means for engaging the plug 52 in a locking relationship, such as depicted in FIGS. 2 and 3 with the coupler 50. The groove 60 comprises or is bounded by a circular forward flange 63 with a leading side face 65 surface.

The present invention is directed to features associated with the coupler 50 wherein the coupler 50 may be combined and locked with the plug 52 as depicted in FIG. 2 or 3 and wherein a sleeve 64 of the coupler may be axially moved to release the plug 52 from engagement with the coupler 50 as depicted in FIG. 3. Thus, the plug 52 may be inserted into the coupler 50 and upon pushing the plug 52 into the entry end or entry opening of the coupler 50, the plug 52 will be engaged and retained as a result of the sleeve 64 sliding axially toward the plug 52 to lock the plug 52 in engagement with coupler 50 as further described hereinafter. The sleeve 64 is manually movable in the reverse axial direction in order to release the plug 52.

Multiple types of plugs 52, 52A and 52B may be utilized with the coupler 50 of the present invention. FIG. 4 depicts an example of a plug 52A which is distinct from the plug 52 depicted in FIGS. 1-3 but which is compatible with the coupler 50 and may be locked in place with the coupler 50 and may be released in the manner previously described. FIG. 5 illustrates yet another style plug 52B which is compatible with and may be engaged with the coupler 50 and locked into engagement therewith and released m the same manner previously described.

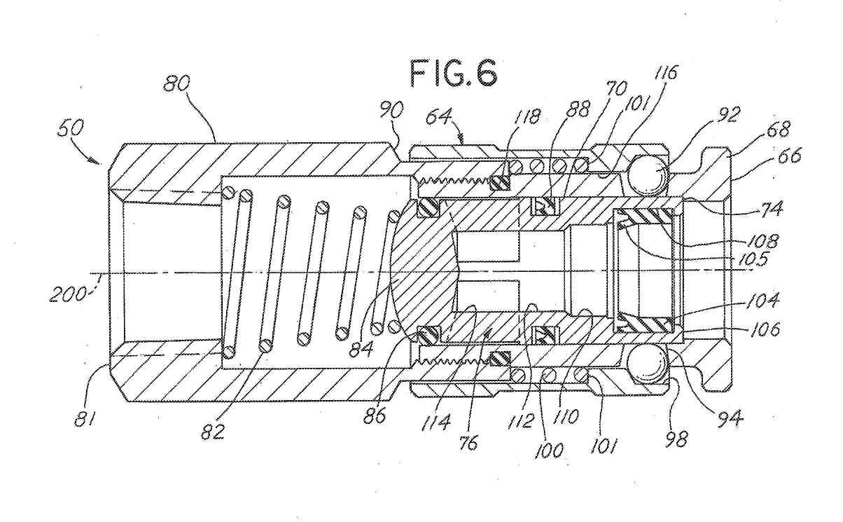

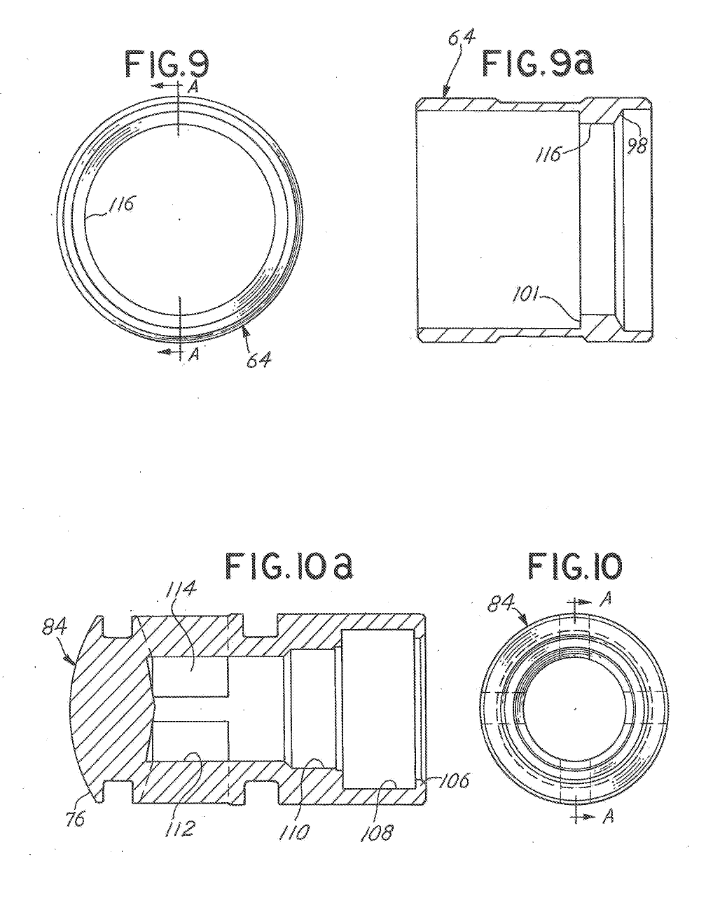

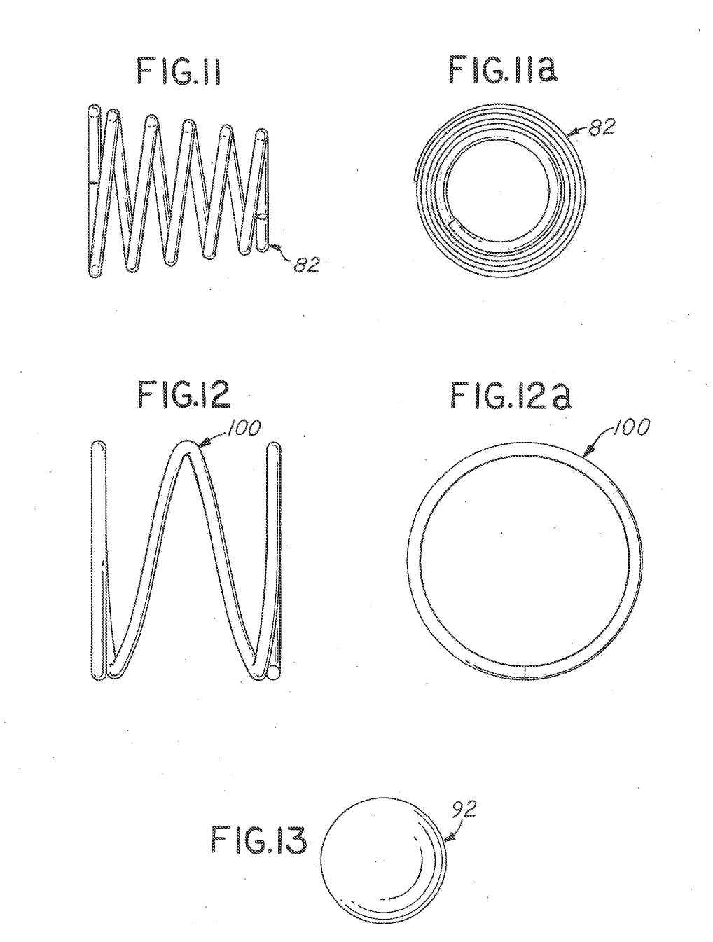

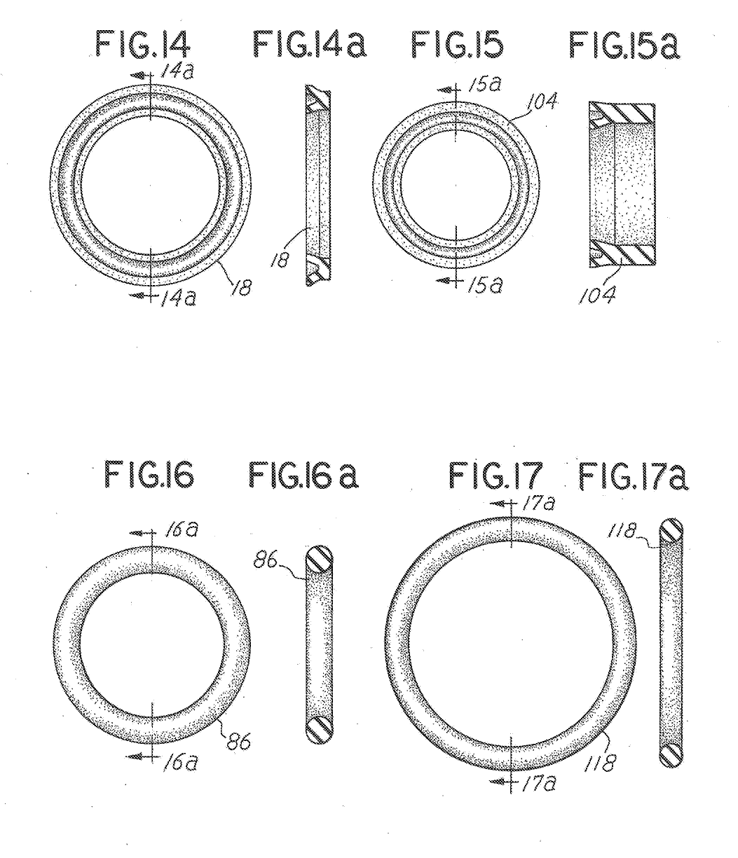

The remaining FIGS. 6-17 illustrate the component parts and assembly of the coupler 50. The coupler assembly is depicted in the sectional view FIG. 6. The remaining figures depict the component parts of coupler 50. The coupler 50 includes a body member 66. The body member is in the form of a generally uniform or constant internal diameter tube with a flange 68 at the outer plug receiving end of the body member 66. The flange 68 extends radially outwardly from the throughbore section 70 as well as inwardly. Thus an inwardly extending lip or land or flange 74 is provided to limit the movement of a valve member 76 axially within the bore 72 as described hereinafter.

A generally constant outside diameter valve member 76 is retained slidably within the compatibly sized cylindrical bore 70 of body member 66 and is limited in movement in the axial direction toward the open end or plug receiving end of the coupler 50 by the flange 74. The valve member 76 is biased in the axial direction by the combination of a female nut 80 having a throughbore and a spiral spring member 82 positioned between the female nut 80 and the inner, closed end 84 of the valve member 76. The female nut 80 is threaded onto the body member 66. External seals 86 and 88 are fitted in grooves in the outside surface of the valve member 76 to provide a seal between the valve member 76 and the body member 66.

The female nut 80 includes an external land 90 which limits the axial extent of movement 81 in one direction which the sleeve 64 may slide toward end 81 of nut 80. This limitation is important inasmuch as the sleeve 64 is designed to retain ball bearings 92 in passages 94 in the body member 66. As depicted in FIG. 6, the sleeve 64 is in a position which enables the ball bearings 92 to partially fit within a counterbore recess 98 in the sleeve 64 and not extend into the throughbore 70. The sleeve 64 is biased by a spring 100 in between the nut 80 and a land 101 of sleeve 64 illustrated in FIG. 6. The valve member 76, when at its most axially forward position toward the plug end 58, maintains the ball bearings 92 in position on the outside surface of the valve member 76.

The valve member 76 includes a series of connected sections 108, 110, 112 in combination comprising a counterbore 102. The counterbore sections decrease in diameter as the counterbore 102 approaches the end 84 of the valve member 76. At the open end of the valve member 76, an annular seal 104 is fitted. The annular seal 164 is retained by a lip 106 within the first section 103 of the counterbore 102. The lip 106 projects radially inwardly from flange 74 of body member 66. The first section 108 connects to a second section 110 which in turn connects to a third section 112. The third section 112 further includes radially extending slots or passages 114. The passages 114 provide a pathway for fluid flow when the valve 76 is moved axially to the left in FIG. 6.

When the valve 76 is moved axially, to the left in FIG. 6, movement is in response to the insertion of a plug 52 (52A or 52B) into the coupler 50. That is a plug 52 with a stem and may be pushed axially into the coupler 50. The plug 52 includes a forward land 63 in FIG. 1 which engages the flange 106 of the valve member 76 and forces the valve member or valve 76 slidably and axially to the left in FIG. 6. Upon being forced axially to the left in FIG. 6, the spring 100 causes the sleeve 64 to more axially to the right in FIG. 6. The balls 92 will then be driven through passages 94 into a groove 60 of the plug 52. Simultaneously, the passages or slots 114 will be exposed to the passageway in nut 80 for airflow. The balls 92 having been forced into the groove 60 of the plug 52 are retained thereby by the means of the sleeve 64 which holds the balls 92 in place. The plug 52 is thereby locked in position as depicted in FIG. 2. Airflow through the plug 52 may then pass through the central passage 53 of the plug 52, then through the valve 76 and passages 114 and out through the female nut 80.

To release the plug 52 from the coupler 50, an operator may manually engage and manipulate the outside surface of the sleeve 64 and move the sleeve 64 axially to the left in FIG. 6. This releases the engagement of the sleeve 64 with the balls 92 and, more particularly, engagement with the reduced diameter section 116 of the sleeve 64. The balls 92 may then reside in the expanded diameter section or recess 98 thereby enabling the plug 52 to be manually pulled to the right in FIG. 6 causing the balls 92 to slide outwardly and into the body member 66. It is noted that the passages 94 for the balls 92 are inwardly divergent which enables the balls 92 to be retained from movement through openings 94 in to the central axial passage in plug 52. An extra seal 118 is provided intermediate the female nut 80 and the body member 66 to ensure that air does not undesirably escape from the coupler construction.

The configuration of the seal 104 is an aspect of the invention. That is, the annular seal 104 has an axially extended dimension within the counterbore and also includes a lip 105. The axial extent of the seal 104 and the lip 105 ensure a tight seal between plugs of various styles and the coupler. Additionally, the reduced diameter counterbore sections 108, 110, 113 and axial dimension thereof engagement and further ensure appropriate alignment of various types of plugs (such as 52, 52A 52B) axially within the counterbore and prevent lateral displacement or transverse movement of the plugs 52, 52A, 52B upon insertion into a coupler 50.

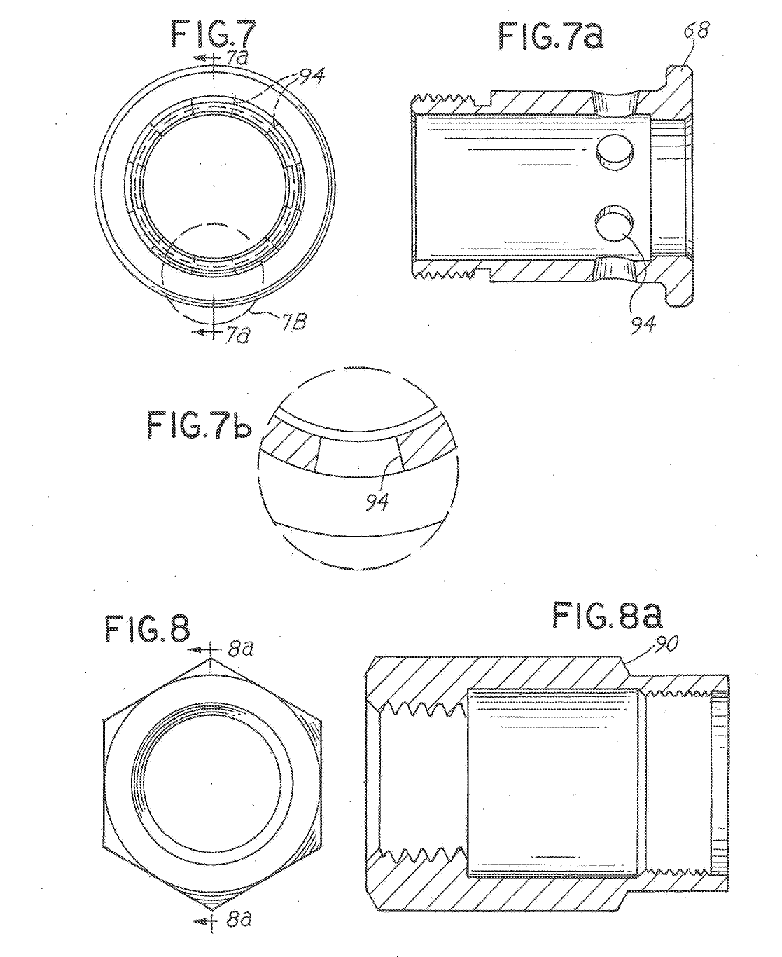

The subsequent FIGS. 7-17 depict in greater detail the component parts of the coupler 50 as depicted in FIG. 6. The component parts are generally symmetrical about a centerline axis 200. However, flanges, lips, passages and other elements may be intermittent or of selected diameter or configuration. It is thus possible to vary the configuration of the various component parts of the coupler 50. The valve 76 may be modified for example by modifying the arrangement of the seals and the counterbore 108, 110, 112 axial and diameter dimensions as well as the number of counterbores. The radial fluid passages 114 may be modified in configuration alignment and placement. Various other modifications are considered to be within the scope of the invention. The invention is therefore limited only by the following claims and equivalents thereof.

What is claimed is:

1. A universal coupler comprising:
a body member including a generally constant diameter through bore with an outwardly extending flange at a plug receiving end and an inwardly extending flange at said plug receiving end, said body member further including a set of radial passages adjacent said plug receiving end and radially displaceable ball retention members located in said radial passages;
a retainer nut attached to the body member at the end opposite the plug receiving end, said nut including an internal through passageway and an external land;
a valve member having a generally constant uniform diameter having substantially the same diameter as the body member throughbore, said valve member slidably, axially movable in said body member between a first position engaging said inwardly extending flange and a second position axially displaced toward said nut, said valve member further including a counterbore extending from a first end adjacent said body member plug receiving end and extending toward the opposite end of said valve member; said counterbore including a series of cylindrical connected sections, each section nearer to the opposite end having a lesser diameter than the next section, the section having the least diameter including radial passages through said valve member,
said valve member further including an inwardly radially extending lip at the open end having a lesser diameter than the inwardly extending flange of said body member whereby said inwardly extending flange of said body member limits axial movement of said valve member beyond said first position;
a biasing member in said nut, said biasing member, engaging and biasing said valve member axially toward said first position;
an external, slidable sleeve on said body member intermediate and movable between said body member outwardly extending flange and said external land of said nut, said sleeve including a ball retention groove for receipt of ball members in said body member when said valve member is in said first position; and
a sleeve biasing element for engaging and biasing said sleeve toward the said body member outwardly extending flange, whereby insertion of a plug into the plug receiving end of the body member enables engagement of a said plug with said valve member lip, subsequent axial movement of said valve member to the second position, axial movement of said sleeve to a first position limited by said body member outwardly extending flange, engagement of said ball retention members with a plug groove and fluid flow through said passages and said nut.

2. The coupler of claim 1 further including at least one seal in said valve member counterbore.

3. The coupler of claim 1 including multiple seals in said valve member counterbore.

4. The coupler of claim 1 wherein the valve member sections comprise at least two adjacent sections having a unique axial dimension.
